(19) United States
(12) Patent Application Publication
(10) Pub. No.: US 2020/0149950 A1
(43) Pub. Date: May 14, 2020

(54) WEIGHT SCALE, METHOD OF MEASURING WEIGHT, AND ANIMAL LITTER BOX

(71) Applicant: Sharp Kabushiki Kaisha, Sakai City, Osaka (JP)

(72) Inventor: NOBUYUKI ASAHARA, Sakai City, Osaka (JP)

(21) Appl. No.: 16/633,356

(22) PCT Filed: Jul. 20, 2018
(86) PCT No.: PCT/JP2018/027298

§ 371 Date: Jan. 23, 2020

(30) Foreign Application Priority Data
Jul. 28, 2017 (JP) 2017-147088

(51) Int. Cl. G01G 23/37; G01G 19/52; G01G 7/02; G01G 3/14; A01K 1/01

(52) U.S. Cl. CPC G01G 23/37; G01G 19/52; A01K 1/0107; G01G 3/14; G01G 7/02

(57) ABSTRACT

A weight scale includes a load cell, an amplifier, and an A/D converter and further includes a CPU that: sets up the amplifier for a first measurement range and a first amplification factor and causes the amplifier to amplify an output voltage of the load cell and the A/D converter to convert an output of the amplifier from analog to digital, to obtain a first weight value of the measurement target; and sets up the amplifier for a second measurement range narrower than the first measurement range and a second amplification factor larger than the first amplification factor and then causes the amplifier to amplify an output voltage of the load cell and the A/D converter to convert an output of the amplifier from analog to digital, to obtain a second weight value of the measurement target.

### TECHNICAL FIELD

The present invention relates to weight scales, methods of measuring weight, and animal litter boxes (toilets), including a load cell or like load sensor, an amplifier, and an A/D converter.

### BACKGROUND ART

Patent Literature 1 is related to exemplary conventional technology for conveniently and accurately measuring the body weight of a companion animal Patent Literature 1 discloses an automatic companion animal body weight measuring system including: weight measuring means, installed below a living space for a companion animal, for measuring the weight of the living space with or without a companion animal in the living space; and weight calculating means for calculating and displaying the weight of the companion animal on the basis of the degree of change of the living space weight data outputted by the weight measuring means.

### CITATION LIST

### Patent Literature

Patent Literature 1: Japanese Unexamined Patent Application Publication, Tokukai, No. 2007-330200 (Publication Date: Dec. 27, 2007)

### SUMMARY OF INVENTION

### Technical Problem

The automatic companion animal body weight measuring system disclosed in Patent Literature 1 listed above includes a weight scale located below a living space (e.g., bed or toilet) for a companion animal, enabling easy measurement of the companion animal's body weight when the companion animal moves into the toilet.

However, individual companion animals vary greatly in body weight. The system therefore needs to provide a wide measurement range and ensure a level of precision across the wide measurement range in order to enable measurement of the body weights of a plurality of individual animals, which in turn requires a high-precision amplifier and a high-resolution analog-to-digital converter. These electric components are disadvantageously costly.

The present invention, made in view of this conventional issue, has an object to provide a weight scale, a method of measuring weight, and an animal litter box that readily enable high-precision weight measurement by using an amplifier and an A/D converter that do not provide high-precision, high-resolution performance.

### Solution to Problem

To address the issue, the present invention, in an aspect thereof, is directed to a weight scale including: a load sensor; an amplifier; an A/D converter; and a control unit configured to: in a preceding weight measurement on a measurement target, set up the amplifier for a first measurement range and a first amplification factor and cause the amplifier to amplify an output voltage of the load sensor and the A/D converter to convert an output of the amplifier from analog to digital, to obtain a first weight value of the measurement target; and in a succeeding weight measurement on the measurement target, set up the amplifier for a second measurement range narrower than the first measurement range and a second amplification factor larger than the first amplification factor and then cause the amplifier to amplify the output voltage of the load sensor and the A/D converter to convert an output of the amplifier from analog to digital, to obtain a second weight value of the measurement target.

To address the issue, the present invention, in an aspect thereof, is directed to a method of measuring weight by using a load sensor, an amplifier, and an A/D converter, the method including: a first step where in a preceding weight measurement on a measurement target, the amplifier is set up for a first measurement range and a first amplification factor to amplify an output voltage of the load sensor, and the A/D converter converts an output of the amplifier from analog to digital, to obtain a first weight value of the measurement target; and a second step where in a succeeding weight measurement on the measurement target, the amplifier is set up for a second measurement range narrower than the first measurement range and a second amplification factor larger than the first amplification factor, then the amplifier amplifies the output voltage of the load sensor, and the A/D converter converts an output of the amplifier from analog to digital, to obtain a second weight value of the measurement target.

To address the issue, the present invention, in an aspect thereof, is directed to an animal litter box including the weight scale described above as a body weight measuring instrument.

### Advantageous Effects of Invention

The present invention, in an aspect thereof, advantageously provides a weight scale, a method of measuring weight, and an animal litter box that readily enable high-precision weight measurement by using an amplifier and an A/D converter that do not provide high-precision, high-resolution performance.

### BRIEF DESCRIPTION OF DRAWINGS

FIG. 1 is a flow chart representing a flow of a measurement process using a weight scale in accordance with Embodiment 1 of the present invention when a measurement is performed on a measurement-target companion animal whose weight is not known.

Portion (a) of FIG. 2 is a perspective view of a companion animal litter box including such a weight scale, and (b) of FIG. 2 is an exploded perspective view of the companion animal litter box.

FIG. 3 is a cross-sectional view of the companion animal litter box.

FIG. 4 is a block diagram of a configuration of a control device for the companion animal litter box.

Portion (a) of FIG. 5 is a graph representing an output, in a first round of measurement, of a built-in load cell in a body weight measuring instrument or a urine weight measuring instrument provided in the companion animal litter box, (b) of FIG. 5 is a graph representing an output of an amplifier, and (c) of FIG. 5 is a graph representing an output of an A/D converter.

Portion (a) of FIG. 6, illustrating how a 2-staged high-precision weight measurement is performed using the body weight measuring instruments in the companion animal litter box, is a graph representing an output of an amplifier when a measurement of 10 kg is obtained in a first stage by using a load cell that has a rating of 20 kg, and (b) of FIG. 6 is a graph representing an output of an A/D converter.

Portion (a) of FIG. 7, illustrating how a 2-staged high-precision weight measurement is performed using the body weight measuring instruments in the companion animal litter box, is a graph representing an output of an amplifier when a measurement of 5 kg is obtained in a first stage by using a load cell that has a rating of 20 kg, and (b) of FIG. 7 is a graph representing an output of an A/D converter.

FIG. 8 is a flow chart representing a flow of a measurement process using a weight scale in accordance with Embodiment 2 of the present invention when a measurement is performed on a measurement-target companion animal whose weight is known.

FIG. 9 is a diagram illustrating a method of measuring the body weights of a plurality of companion animals using a companion animal litter box including a weight scale in accordance with Embodiment 3 of the present invention, by obtaining individual animal IDs from information terminals included in the collars of individual companion animals.

FIG. 10 is a block diagram of a configuration of a control device for the companion animal litter box along with the information terminal included in the collar of each companion animal.

FIG. 11 is a flow chart representing a process of measuring the body weights of a plurality of companion animals using the companion animal litter box, by obtaining individual animal IDs from information terminals included in the collars of individual companion animals.

### DESCRIPTION OF EMBODIMENTS

### Embodiment 1

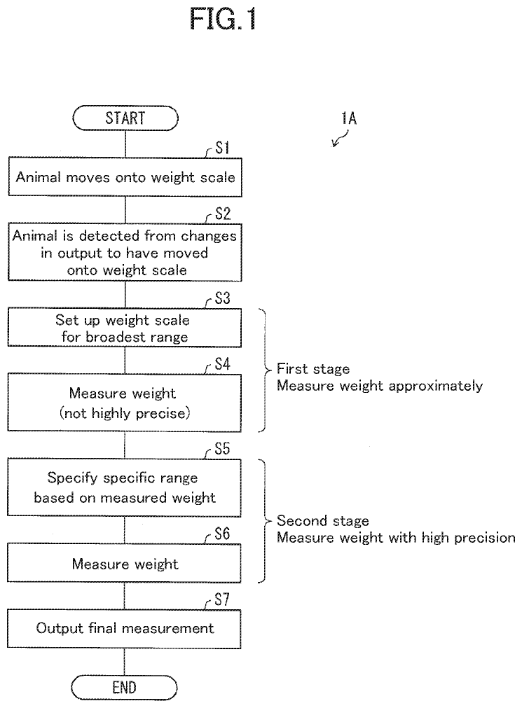

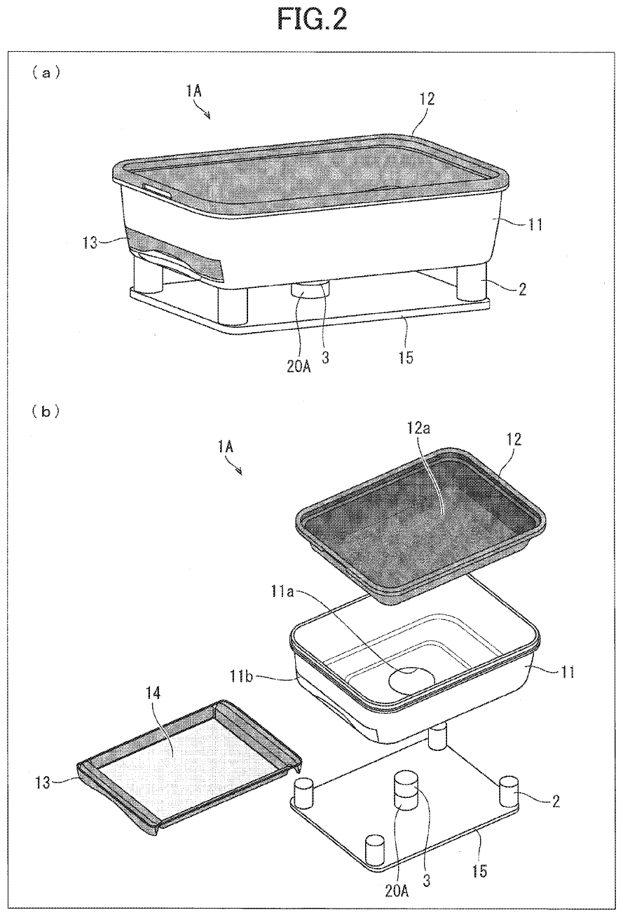

The following will describe an embodiment of the present invention with reference to FIGS. 1 to 7.

A companion animal litter box, as an animal litter box including a weight scale in accordance with the present embodiment, is a companion animal toilet that measures the body weight of a companion animal and that also measures the amount of the urine excreted by the companion animal Examples of companion animals may include domestic animals such as cats and dogs. In some aspects of the present invention, the animal litter box is not necessarily used by a cat or dog and may be used by other animals.

### Structure of Companion Animal Litter Box

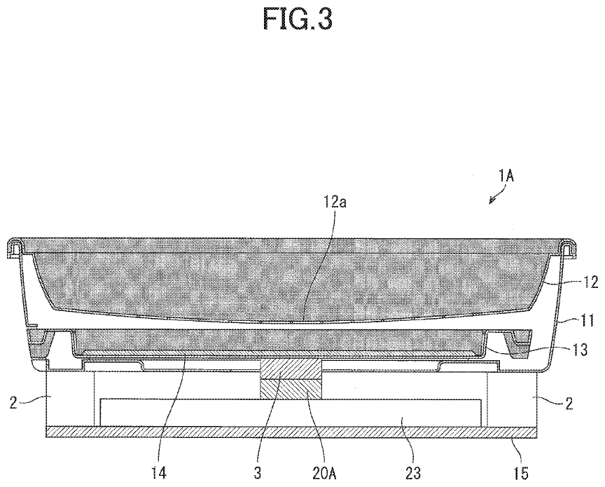

Referring to (a) and (b) of FIG. 2 and FIG. 3, a description will be now given of a structure of a companion animal litter box 1A as an animal toilet including a weight scale in accordance with the present embodiment. Portion (a) of FIG. 2 is a perspective view of the companion animal litter box 1A including body weight measuring instruments 2 as a weight scale in accordance with the present embodiment. Portion (b) of FIG. 2 is an exploded perspective view of the companion animal litter box 1A. FIG. 3 is a cross-sectional view of the companion animal litter box 1A.

The companion animal litter box 1A in accordance with the present embodiment functions as a body weight measuring device for measuring the body weight of an animal which is a companion animal as shown in (a) and (b) of FIG. 2 and FIG. 3. The companion animal litter box 1A includes a main body container 11, a scale tray 12, a litter tray 13, an absorbent sheet 14, a support unit 15, the body weight measuring instruments 2, a urine weight measuring instrument 3, a control device 20A, and a cover (not shown).

The main body container 11 holds the scale tray 12 therein. The bottom of the main body container 11 has a central hole 11a at the center thereof so that the urine weight measuring instrument 3 protrudes through the central hole 11a.

The scale tray 12 provides a platform for a companion animal to sit or stand on for urination and/or defecation. The scale tray 12 has a mesh 12a through the bottom thereof. The urine excreted by the companion animal passes through the mesh 12a and falls onto the absorbent sheet 14 spread in the litter tray 13. The mesh 12a passes liquids, but not feces and solid materials that the animal brings into the toilet. The scale tray 12 may have a hole, instead of the mesh 12a, for excreta to pass through. The scale tray 12 is shaped like a hollow container in the present embodiment, but may take any shape so long as the scale tray 12 permits an animal to sit or stand thereon for measurement of its body weight.

The litter tray 13 is disposed below the scale tray 12 to receive urine. The litter tray 13 is capable of receiving materials falling in an area that envelops the mesh 12a of the scale tray 12. The litter tray 13 can be put into, and taken out of, the main body container 11 through a side hole 11b opened in a side face of the main body container 11.

The absorbent sheet 14 absorbs liquids such as urine. The absorbent sheet 14 is convenient in that it can be discarded and replaced with a new one after absorbing a liquid such as urine, but not essential to the invention.

The support unit 15 is a foundation plate supporting the body weight measuring instruments 2 and the urine weight measuring instrument 3. The support unit 15, in the present embodiment, carries thereon the control device 20A below the urine weight measuring instrument 3.

The body weight measuring instruments 2 support a structural body including at least the scale tray 12. More specifically, the body weight measuring instruments 2 support a structural body including the main body container 11 and the scale tray 12.

In the present embodiment, as an example, there are provided four body weight measuring instruments 2, one for each corner of the bottom of the main body container 11 in such a manner that the body weight measuring instrument 2 is in contact with the corner. The body weight measuring instruments 2 each include a load cell as a load sensor to measure the total weight of the animal and the structural body including the main body container 11 and the scale tray 12. The body weight measuring instruments 2 output measurements to the control device 20A.

The urine weight measuring instrument 3 is in contact with the litter tray 13 through the central hole 11a in the bottom of the main body container 11 to support the litter tray 13. The urine weight measuring instrument 3 includes a load cell as a load sensor to measure the weight of the litter tray 13 including the absorbent sheet 14 and the urine. The litter tray 13 does not receive the weight of the scale tray 12 and the companion animal The urine weight measuring instrument 3 outputs a measurement to the control device 20A.

The body weight measuring instruments 2 (body weight scale) and the urine weight measuring instrument 3, in the present embodiment, each include a load cell as a load sensor. The load cell detects a change in voltage that results from a change in resistance under strain. The load cell outputs analog values. Digitization of these values therefore usually necessitates an amplifier 22 and an A/D converter 23. In an aspect of the present invention, however, the load sensor is not necessarily a load cell and may be, for example, an electromagnetic weight scale. An electromagnetic weight scale exploits electromagnetic force to balance the scale and detects an electric current when the scale is balanced. This type of weight scale also outputs analog values. Therefore, electromagnetic weight scales also generally need the amplifier 22 and the A/D converter 23 to generate digital outputs.

### Configuration of Control Device

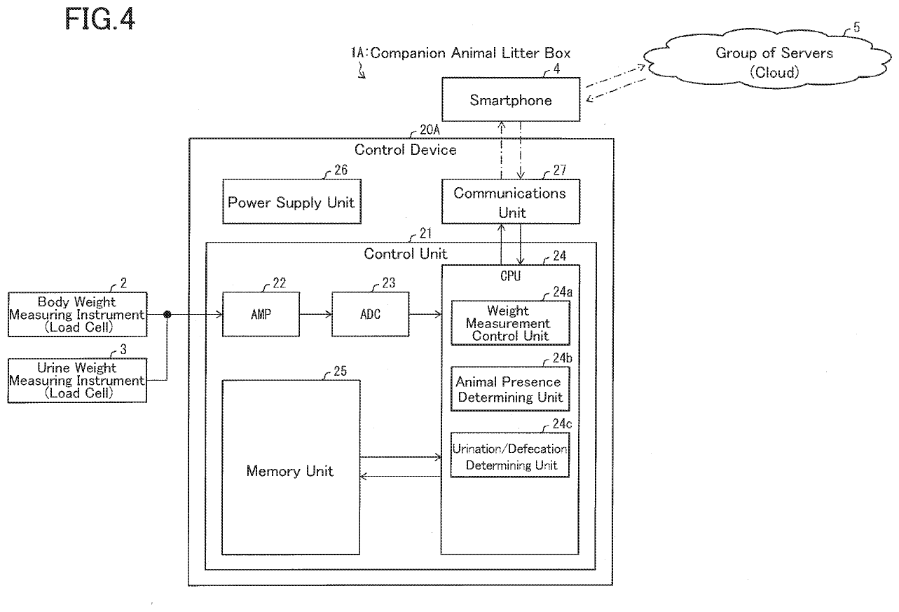

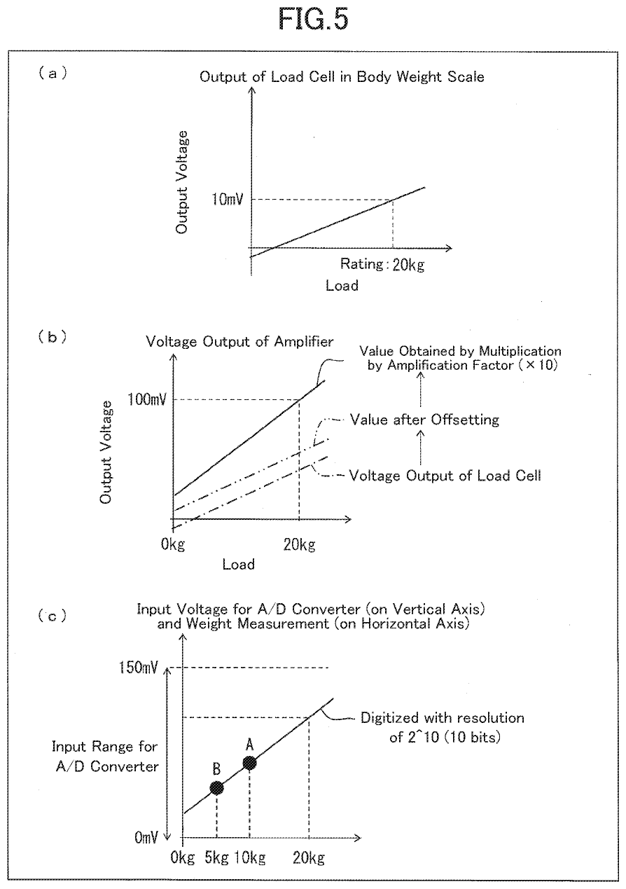

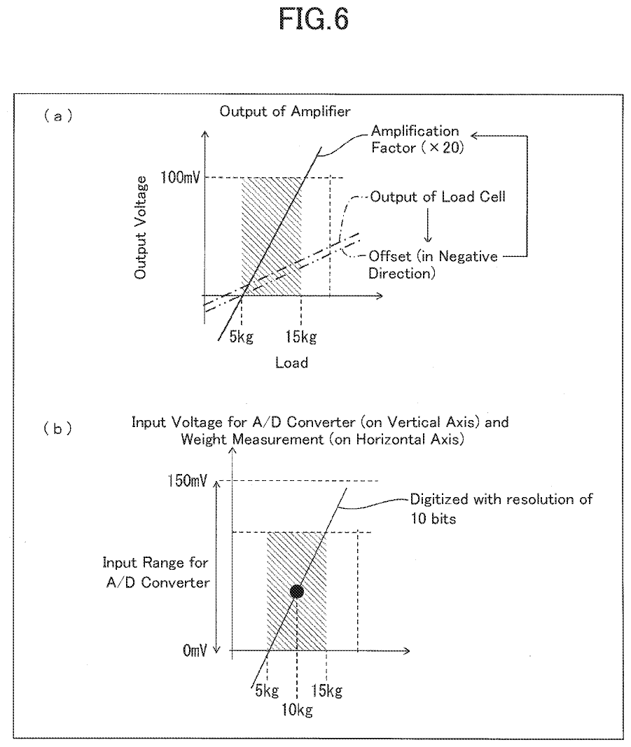

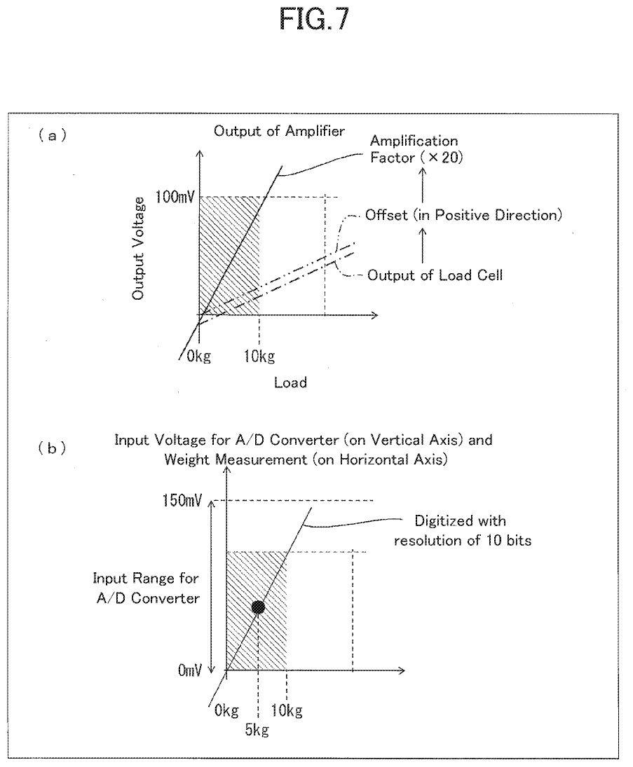

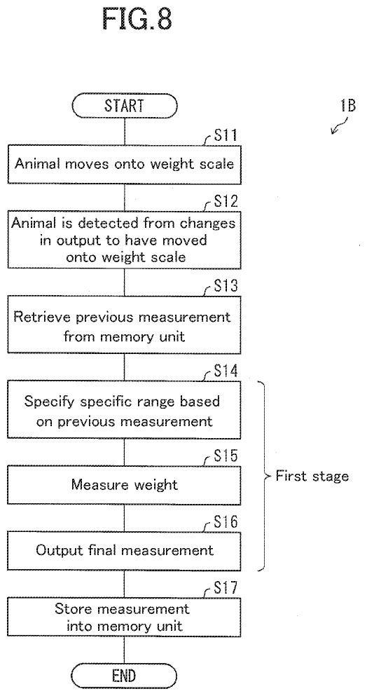

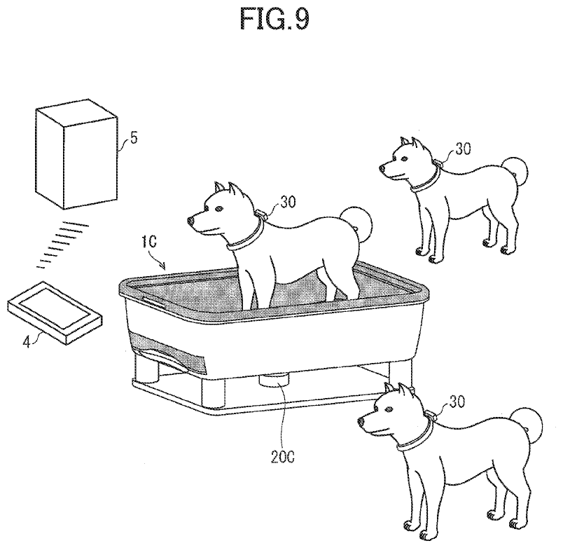

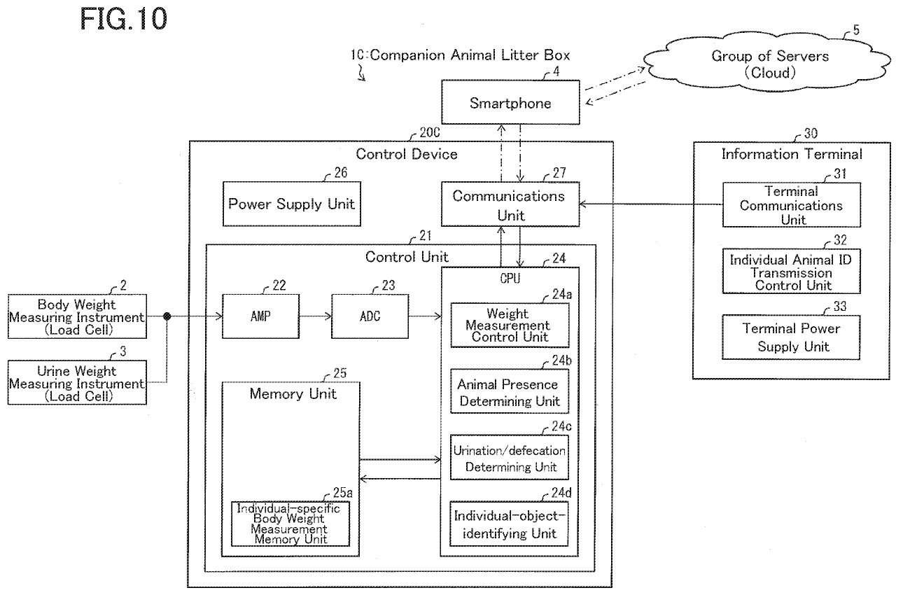

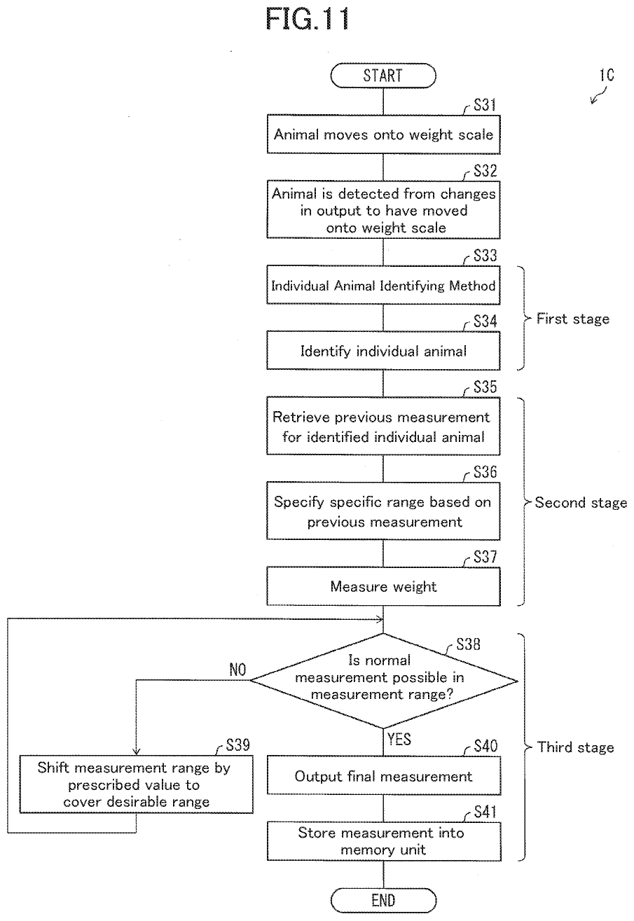

A description will be given of a configuration of the control device 20A in the companion animal litter box 1A in accordance with the present embodiment with reference to FIG. 4. FIG. 4 is a block diagram of a configuration of the control device 20A in the companion animal litter box 1A in accordance with the present embodiment.

Referring to FIG. 4, the control device 20A includes a control unit 21, a power supply unit 26, and a communications unit 27. The control unit 21 includes the amplifier 22, the A/D converter (analog-to-digital converter) 23, a central processing unit (CPU) 24, and a memory unit 25.

The CPU 24 in the control unit 21 of the present embodiment includes a weight measurement control unit 24a, an animal presence determining unit 24b, and a urination/defecation determining unit 24c to measure weight.

The weight measurement control unit 24a controls the amplifier 22 and the A/D converter 23 in such a manner that the amplifier 22, set up for a prescribed measurement range, amplifies the output voltages generated in the measurement by the load cells in the body weight measuring instruments 2 and the urine weight measuring instrument 3 and that the A/D converter 23 converts the amplified analog voltages to digital values, in order to obtain measurements. The animal presence determining unit 24b determines whether or not the companion animal is on the scale tray 12. The urination/defecation determining unit 24c determines whether or not the companion animal has excreted urine.

Specifically, the CPU 24 implements control to determine the body weight of the companion animal and the weight of the urine excreted by the companion animal The CPU 24 performs the following control to measure the body weight of the companion animal

The measurements from the body weight measuring instruments 2 indicate the total weight of the companion animal and the structural body including the main body container 11 and the scale tray 12. When there is no companion animal on the scale tray 12, the companion animal has a zero weight.

The animal presence determining unit 24b, when the measurements from the body weight measuring instruments 2 have increased, determines that the companion animal has moved onto the scale tray 12. When the measurements from the body weight measuring instruments 2 have decreased while the measurement from the urine weight measuring instrument 3 stays unchanged, the animal presence determining unit 24b determines that the companion animal has moved down from the scale tray 12.

The weight measurement control unit 24a then determines, as the weight of the companion animal, the difference in the measurements from the body weight measuring instruments 2 before and after the companion animal moves onto the scale tray 12.

Meanwhile, the CPU 24 performs the following control to measure the weight of the urine excreted by the companion animal.

The measurement from the urine weight measuring instrument 3 indicates the weight of the litter tray 13 including the absorbent sheet 14 and the excreted urine.

The urination/defecation determining unit 24c, when the measurement from the urine weight measuring instrument 3 has changed, determines that the companion animal has excreted urine. The weight measurement control unit 24a determines the weight of the urine on the basis of the amount of change in the measurement. Specifically, the weight measurement control unit 24a subtracts the measurement taken before the companion animal excretes urine from the measurements taken after the companion animal excretes urine, to determine the weight of the excreted urine.

The weight measurement control unit 24a stores the measurements from the body weight measuring instruments 2 and the urine weight measuring instrument 3 in the memory unit 25. In the measurement of the weight of an individual animal (measurement target), the weight measurement control unit 24a retrieves a previous weight measurement for the individual animal and sets up the amplifier 22 and the A/D converter 23 for a range with a middle value equal to the retrieved previous weight measurement. In the absence of a previous weight measurement for the individual animal, if there exists a weight measurement for the individual animal available by any other method, the weight measurement control unit 24a sets up the amplifier 22 and the A/D converter 23 for a range with a middle value equal to that available weight measurement.

The weight measurement control unit 24a then sends the weight measurement stored in the memory unit 25 to, for example, a smartphone 4 via the communications unit 27 capable of Bluetooth® or like near-field communications. This configuration enables data transmission to a cloud 5 (group of servers) connected to the Internet.

The power supply unit 26 feeds power to various components of the control device 20A including the amplifier 22, the A/D converter 23, the CPU 24, the memory unit 25, and the communications unit 27. The power supply unit 26 may be, for example, a rechargeable battery or a dry-cell battery. As a further alternative, the power supply unit 26 may be an external power supply device.

The companion animal litter box 1A described above is a mere example of toilets for companion animals. In an aspect of the present invention, the companion animal litter box 1A may be another type of toilet for companion animals so long as the companion animal litter box 1A includes a weight scale and a microcomputer that is the control unit 21 including the amplifier 22, the A/D converter 23, and the CPU 24.

Configuration for Obtaining Weight with High Precision by Using General-Purpose Amplifier and A/D Converter

The control unit 21 including a microcomputer with the built-in CPU 24 includes the general-purpose amplifier 22 and A/D converter 23, to measure the body weight of the companion animal and the weight of urine in the companion animal litter box 1A configured as above. These general-purpose amplifier 22 and A/D converter 23 however do not provide high-precision, high-resolution performance. Accordingly, the weight scale in accordance with the present embodiment is so configured as to readily achieve high-precision weight measurement by using such a general-purpose amplifier 22 and A/D converter 23.

Referring to FIG. 4 and (a), (b), and (c) of FIG. 5, a common method of measuring weight that involves the use of a load cell, the amplifier 22, and the A/D converter 23 will be first described as a method of measuring weight that involves the use of the general-purpose amplifier 22 and A/D converter 23. Portion (a) of FIG. 5 is a graph representing an output of a load cell, (b) of FIG. 5 is a graph representing an output of the amplifier 22, and (c) of FIG. 5 is a graph representing an output of the A/D converter 23.

As shown in FIG. 4, to measure weight by using the body weight measuring instruments 2 and the urine weight measuring instrument 3, the amplifier 22 amplifies an output voltage of a load cell, the A/D converter 23 converts the amplified voltage from analog to digital, and the CPU 24 processes the converted voltage value. For this purpose, the amplification factor and offset of the amplifier 22 and the resolution of the A/D converter 23 are specified in accordance with a measurable range (i.e., measurement range) and a precision level.

Specifically, as shown in (a) of FIG. 5, as an example, the load cell in the body weight measuring instrument 2 is set up, for example, to output 10 mV for a rated load of 20 kg. The amplifier 22 amplifies this output voltage of the load cell. Under such settings, the output voltage of the load cell may go negative for a light load as indicated by a dash-dot line in (b) of FIG. 5. Accordingly, in the amplifier 22, the characteristic line is offset as indicated by a dash-double-dot line in (b) of FIG. 5, to output a positive value for the minimum load value (=0 kg). The amplifier 22 thus amplifies, by, for example, an amplification factor a, the voltage represented by the offset straight line representing the relationship between the load and the output voltage of the load cell, thereby generating the solid line in (b) of FIG. 5 (amplified straight line). The amplification factor a is equal to 10 in this example.

Next, the output voltage of the amplifier 22 is fed to the A/D converter 23 where the output voltage (analog data) of the amplifier 22 is converted to digital values with a resolution of b. Assume here that the resolution b is equal to 10 bits as an example. That the resolution b is equal to 10 bits means that if the A/D converter 23 has an input range of, for example, 0 to 150 mV, this input range is equally divided by 2\hat{ }b (2 to the b-th power)=2\hat{ }10 for digitization and conversion to a weight. Through these procedures, for example, a weight of 10 kg and a weight of 5 kg are obtained for A and B respectively as indicated by a solid line in (c) of FIG. 5.

The amplifier 22 and the A/D converter 23 need to have high precision and high resolution capabilities respectively to achieve high precision across a wide measurement range according to the measurement principles described above. Meanwhile, current microcomputers with a built-in CPU 24, often including general-purpose amplifiers and A/D converters, do not provide high-precision, high-resolution performance. Some A/D converters are capable of a high resolution of, for example, 24 bits, but they are costly.

The present embodiment accordingly provides a weight scale capable of substantially high-precision, high-resolution measurement by means of a 2-staged measurement process with different measurement ranges.

A description will be given of a method capable of this substantially high-precision, high-resolution measurement with reference to (a) and (b) of FIG. 6. Portion (a) of FIG. 6, illustrating how a 2-staged high-precision weight measurement is performed using the body weight measuring instruments 2 in the companion animal litter box 1A, is a graph representing an output of the amplifier 22 when a measurement of 10 kg is obtained in a first stage by using a load cell that has a rating of 20 kg, and (b) of FIG. 6 is a graph representing an output of the A/D converter 23.

In the first stage, body weight is measured by the method illustrated in (a), (b), and (c) of FIG. 5. The measurement obtained in the first stage will be referred to as the first measurement. The amplifier 22 is switched to a different measurement range in the present embodiment for a second-stage body weight measurement.

Suppose, for instance, that the first measurement obtained in a first-stage weight measurement is 10 kg. In response to this, the second-stage weight measurement is performed by narrowing down the range to around the first measurement in the present embodiment. Specifically, the characteristic line of the amplifier 22 is offset, and its amplification factor is readjusted, such that the output of the amplifier 22 for the range of approximately the first measurement plus and minus a few kilograms falls in the input range of the A/D converter 23 as much as possible. The output of the amplifier 22 may alternatively fall in a prescribed subrange (e.g., 0 to 100 mV) of the entire input range (e.g., 0 to 150 mV) of the A/D converter 23 in such a manner that a measurement is obtained even if the measurement target has a weight that slightly exceeds the rated weight (20 kg). For instance, the characteristic line of the amplifier 22 is offset toward the negative (−) domain as indicated by a dash-double-dot line in (a) of FIG. 6 from the output voltage of the load cell indicated by a dash-dot line in (a) of FIG. 6. The measurement range of the amplifier 22 is then reset to 5 kg to 15 kg, and the amplification factor a of the amplifier 22 is reset to 20, as opposed to 10 in the first stage.

These offset and resetting procedures produce an amplified straight line indicated by a solid line in (a) of FIG. 6. Next, similarly to the first-stage measurement, assuming that the A/D converter 23 has an input range of, for example, from 0 to 150 mV, this input range is equally divided by 2\hat{ }b (2 to the b-th power)=2\hat{ }10 for digitization and conversion to weights as shown in (b) of FIG. 6. A weight value of 10 kg is hence obtained as shown in (b) of FIG. 6, in which case the measurement precision increases to twice that of the first-stage measurement.

Next, a description will be given similarly of a second-stage weight measurement with reference to (a) and (b) of FIG. 7, assuming that the first measurement from the first stage is, as an example, 5 kg. Portion (a) of FIG. 7, illustrating how a 2-staged high-precision weight measurement is performed using the body weight measuring instruments 2 in the companion animal litter box 1A, is a graph representing an output of the amplifier 22 when a measurement of 5 kg is obtained in the first stage by using a load cell that has a rating of 20 kg, and (b) of FIG. 7 is a graph representing an output of the A/D converter 23.

In the first stage, weight is measured by the method illustrated in (a), (b), and (c) of FIG. 5. The first measurement obtained in the first stage is 5 kg. The measurement range of the amplifier 22 is therefore reset to 0 kg to 10 kg for weight measurement in the second stage.

If the first measurement is equal to 5 kg, the measurement is small. The characteristic line of the amplifier 22 is therefore offset toward the positive (+) domain as indicated by a dash-double-dot line in (a) of FIG. 7 from the output voltage of the load cell indicated by a dash-dot line in (a) of FIG. 7. The amplification factor a of the amplifier 22 is then reset to 20, as opposed to 10 in the first stage.

These offset and resetting procedures produce an amplified straight line indicated by a solid line in (a) of FIG. 7. Next, similarly to the first-stage measurement, assuming that the A/D converter 23 has an input range of, for example, from 0 to 150 mV, this input range is equally divided by 2\hat{ }b (2 to the b-th power)=2\hat{ }10 for digitization and conversion to weights as shown in (b) of FIG. 7. A weight value of 5 kg is hence obtained as shown in (b) of FIG. 7, where the measurement precision increases to twice that of the first-stage measurement.

A description will be given next of a flow of a 2-staged measurement process with different measurement ranges in accordance with the present embodiment with reference to FIG. 1. FIG. 1 is a flow chart representing a flow of a measurement process when a measurement is performed on a measurement-target companion animal whose weight is not known.

Referring to FIG. 1, as the measurement-target companion animal moves onto the scale tray 12 of the companion animal litter box 1A (S1), the control device 20A determines from changes in the outputs of the load cells in the body weight measuring instruments 2 that the measurement-target companion animal has moved onto the scale tray 12 of the companion animal litter box 1A (S2).

The control device 20A then sets the measurement range of the amplifier 22 to the broadest range (S3). Since the load cells used in this example have a rating of 20 kg, the measurement range of the amplifier 22 and the maximum measurement range of the A/D converter 23 are set to 0 to 20 kg. The first measurement is performed using these settings (S4).

Next, the measurement range of the amplifier 22 and the measurement range of the A/D converter 23 are reset to a specific measurement range on the basis of the first measurement (S5). For instance, if the first measurement is, for example, 10 kg, the measurement range of the amplifier 22 and the measurement range of the A/D converter 23 are reset to, for example, 5 to 15 kg for the second stage. In other words, the measurement range of the amplifier 22 and the measurement range of the A/D converter 23 for the second stage are respectively less than the measurement range of the amplifier 22 and the measurement range of the A/D converter 23 for the first stage. To describe it in more detail, the measurement range of the amplifier 22 for the second stage extends across the first measurement, is narrower than the measurement range of the amplifier 22 for the first stage, and falls entirely in the measurement range of the amplifier 22 for the first stage. A similar description applies to the measurement range of the A/D converter 23. The offset and amplification factor of the amplifier 22 are determined, for example, such that the output of the amplifier 22 when the measurement range of the amplifier 22 is 5 to 15 kg (the measurement range of the amplifier 22 for the second stage) corresponds to the prescribed input range of the A/D converter 23 (0 to 100 mV).

Weight is measured again under these conditions (S6). The measurement obtained in the second stage is then taken as the final measurement (S7).

As an example, if the measurement range of the amplifier 22 and the measurement range of the A/D converter 23 are set to 0 to 20 kg (Δ=20 kg) for the first stage and to 5 to 15 kg (Δ=10 kg) for the second stage, a measurement is obtained with twice the precision. As another example, if the measurement range of the amplifier 22 and the measurement range of the A/D converter 23 are set to 0 to 20 kg (Δ=20 kg) for the first stage and to 7.5 to 12.5 kg (Δ=5 kg) for the second stage, a measurement is obtained with 4 times the precision.

To give a general solution, a measurement is obtained with n times the precision if the measurement range of the amplifier 22 and the measurement range of the A/D converter 23 are set to Δx kg for the first stage and to Δy=(Δx/n) kg for the second stage. The flow chart shows the first stage measurement as S3 to S4 and the second stage measurement as S5 to S6.

The body weight measuring instruments 2 as a weight scale in accordance with the present embodiment are provided with a load cell or like load sensor, the amplifier 22 as an amplifier, the A/D converter 23 as an A/D converter, and the CPU 24 as a control unit, as described here. The CPU 24 sets up the amplifier 22 for a first measurement range and a first amplification factor to perform a first weight measurement (i.e., preceding weight measurement) on a measurement target, and then causes the amplifier 22 to amplify an output voltage of the load sensor and the A/D converter 23 to convert an output of the amplifier 22 from analog to digital, to obtain a first weight value of the measurement target. The CPU 24 then sets up the amplifier 22 for a second measurement range narrower than the first measurement range and a second amplification factor that is larger than the first amplification factor for a second weight measurement (i.e., succeeding weight measurement) on the measurement target, and thereafter causes the amplifier 22 to amplify the output voltage of the load sensor and the A/D converter 23 to convert the output of the amplifier 22 from analog to digital, to obtain a second weight value of the measurement target.

In this configuration, even if the amplifier 22 and the A/D converter 23, which do not provide high-precision, high-resolution performance, are used, an approximate measurement is obtained in the first weight measurement (i.e., preceding weight measurement). The measurement range of the amplifier 22 is then narrowed down to the second measurement range on the basis of the approximate measurement, so that the amplifier 22 is set up for the second, larger amplification factor. As a result, the second weight value of the measurement target obtained in the second weight measurement (i.e., succeeding weight measurement) is more precise than the first weight value of the measurement target obtained in the first weight measurement.

The present embodiment simply uses twice the amplifier 22 and the A/D converter 23, which do not provide high-precision, high-resolution performance, in order to obtain this second, high-precision weight value. The present embodiment thus generates a substantially high-precision, high-resolution measurement by using a simple configuration.

The present embodiment hence provides the body weight measuring instruments 2 that readily enable high-precision weight measurement by using an amplifier and an A/D converter that do not provide high-precision, high-resolution performance.

Additionally, for the body weight measuring instruments 2 in accordance with the present embodiment, if the output voltage of a load sensor such as a load cell is to be amplified by the amplifier 22, the CPU 24 corrects the output voltage of the load sensor and causes the amplifier 22 to amplify by the first amplification factor or the second amplification factor, such that the output of the amplifier 22 falls in the input range of the A/D converter 23 when the amplifier 22 is set up for the first measurement range or the second measurement range.

This configuration, when the amplifier 22 is set up for the first measurement range or the second measurement range, enables the amplifier 22 to output a voltage that falls in the input range of the A/D converter 23 across the first measurement range or the second measurement range. The configuration thereby generates normal first and second weight values.

A method of measuring weight in accordance with the present embodiment measures weight using a load sensor such as a load cell, the amplifier 22, and the A/D converter 23. The method of measuring weight includes: a first step where in a previous weight measurement on a measurement target, the amplifier 22 is set up for a first measurement range and a first amplification factor to amplify an output voltage of the load sensor, and the A/D converter 23 converts an output of the amplifier 22 from analog to digital, to obtain a first weight value of the measurement target; and a second step where in a succeeding weight measurement on the measurement target, the amplifier 22 is set up for a second measurement range narrower than the first measurement range and a second amplification factor larger than the first amplification factor, then the amplifier 22 amplifies the output voltage of the load sensor, and the A/D converter 23 converts the output of the amplifier 22 from analog to digital, to obtain a second weight value of the measurement target.

The present embodiment hence provides a method of measuring weight that readily enables high-precision weight measurement by using the amplifier 22 and the A/D converter 23, which do not provide high-precision, high-resolution performance.

The companion animal litter box 1A, as an animal toilet in accordance with the present embodiment, includes the body weight measuring instruments 2 as a weight scale. The present embodiment hence provides the companion animal litter box 1A including a weight scale that readily enables high-precision weight measurement by using an amplifier and an A/D converter that do not provide high-precision, high-resolution performance.

The present embodiment has been described as being applied to the body weight measuring instruments 2 (weight scale). The present invention, in other aspects thereof, is not necessarily limited to this example and may be applied to the urine weight measuring instrument 3 (weight scale).

### Embodiment 2

The following will describe another embodiment of the present invention with reference to FIG. 8. The present embodiment has the same structure and configuration as does Embodiment 1 unless otherwise mentioned explicitly. In addition, for convenience of description, members of the present embodiment that have the same function as members shown in drawings for Embodiment 1 are indicated by the same reference numerals, and description thereof is omitted.

In the companion animal litter box 1A in accordance with Embodiment 1, a weight scale was described that is capable of substantially high-precision, high-resolution measurement when the weight of the measurement-target companion animal is not known. In contrast, in a companion animal litter box 1B in accordance with present Embodiment 2, a weight scale will be described that is capable of substantially high-precision, high-resolution measurement when the weight of the measurement-target companion animal is known.

A description will be given next of a flow of a measurement process implemented by the companion animal litter box 1B in accordance with the present embodiment when the weight of the measurement-target companion animal is known, with reference to FIG. 8. FIG. 8 is a flow chart representing a flow of a measurement process when the weight of the measurement-target companion animal is known.

For instance, if the body weight of the measurement-target companion animal is measured every day using the companion animal litter box 1B, and if only the body weight of the measurement-target companion animal is measured using the companion animal litter box 1B, the memory unit 25 as a first memory unit stores the body weight measurement for each day. Therefore, in this case, because there is a predicted value available in advance for the measurement-target companion animal, the first stage measurement described in Embodiment 1 can be omitted.

Accordingly, in the present embodiment, if the weight of the measurement-target companion animal is stored in the memory unit 25 and therefore known, the first stage measurement is omitted, and a substantially high-precision, high-resolution measurement can be obtained by the following flow.

Specifically, referring to FIG. 8, as the measurement-target companion animal moves onto the scale tray 12 of the companion animal litter box 1B (S11), the control device 20A determines from changes in the outputs of the load cells in the body weight measuring instruments 2 that the measurement-target companion animal has moved onto the scale tray 12 of the companion animal litter box 1A (S12).

The control device 20A then retrieves a previous measurement for the measurement-target companion animal from the memory unit 25 (S13).

Next, the control device 20A sets the measurement range of the amplifier 22 and the measurement range of the A/D converter 23 to a specific measurement range on the basis of the measurement retrieved from the memory unit 25 (S14). For instance, when the retrieved measurement is 10 kg, the control device 20A sets the measurement range of the amplifier 22 to a range of 5 kg to 15 kg that is narrower than the rated range (0 kg to 20 kg). Weight is measured under these conditions (S15). The measurement obtained in this stage is then taken as the final measurement (S16).

Next, this final measurement is stored again in the memory unit 25 (S17).

As described here, the body weight measuring instruments 2 in the companion animal litter box 1B in accordance with the present embodiment are provided with the memory unit 25 as the first memory unit for storing a weight value for a measurement target. The CPU 24 sets up the amplifier 22 for a second measurement range and a second amplification factor on the basis of a weight value obtained in a previous weight measurement and stored in the memory unit 25 to perform weight measurement on a measurement target, and then causes the amplifier 22 to amplify an output voltage of a load sensor such as a load cell and the A/D converter 23 to convert the output of the amplifier 22 from analog to digital, to obtain a second weight value of the measurement target.

Accordingly, the present embodiment can perform the second measurement on the measurement target for obtaining a high-definition measurement by omitting the first measurement on the measurement target and setting up, from the start of the measurement process, the amplifier for the second measurement range and the second amplification factor on the basis of the second weight value obtained previously and stored in the memory unit 25. The present embodiment hence saves time.

### Embodiment 3

The following will describe a further embodiment of the present invention with reference to FIGS. 9 to 11. The present embodiment has the same structure and configuration as Embodiments 1 and 2 unless otherwise mentioned explicitly. In addition, members of the present embodiment that have the same function as members shown in drawings for Embodiments 1 and 2 are indicated by the same reference numerals, and description thereof is omitted.

In a companion animal litter box 1C in accordance with the present embodiment, as shown in FIG. 9, a description will be given assuming that there is involved a plurality of companion animals as an example and that an individual animal ID is obtained from an information terminal included in the collar of each companion animal, to measure the body weight of the companion animal.

A description will be given of a configuration of the companion animal litter box 1C in accordance with the present embodiment with reference to FIG. 10. FIG. 10 is a block diagram of a configuration of a control device 20C in the companion animal litter box 1C in accordance with the present embodiment and an information terminal 30 included in the collar of a companion animal.

A description will be given first of a configuration of the information terminal 30 included in the collar of the companion animal. Referring to FIG. 10, the information terminal 30, included in the collar of the companion animal, includes a terminal communications unit 31, an individual animal ID transmission control unit 32, and a terminal power supply unit 33.

The individual animal ID transmission control unit 32 transmits a signal serving as an individual-object-identifying indicator for the companion animal to the control device 20 in the companion animal litter box 1C via the terminal communications unit 31. The signal serving as an individual-object-identifying indicator is information for identifying an individual companion animal. Each companion animal is identified in the present embodiment through a signal, as an exemplary individual animal ID, that falls in a wavelength range specified for each companion animal for transmission from the terminal communications unit 31. A signal that falls in a wavelength range specified for each companion animal may be, for example, a signal transmitted using a wavelength range unique to that companion animal. The present embodiment is not necessarily limited to this example. The information terminal 30 may alternatively include an RFID (radiofrequency identifier) tag as an individual-object-identifying indicator for each companion animal. The RFID tag contains an individual-object-identifying indicator embedded as ID information for a companion animal and is capable of exchanging information by near-field communications (from a few centimeters to a few meters, depending on the frequency band) using, for example, an electromagnetic field and radio waves. As another alternative, the information terminal 30 may transmit ID information serving as an individual-object-identifying indicator for the companion animal to the control device 20C in the companion animal litter box 1C by, for example, wireless communications such as Bluetooth®.

The terminal communications unit 31 transmits an individual animal ID by near-field communications such as Bluetooth®.

The terminal power supply unit 33 is a power supply for driving the terminal communications unit 31 and the individual animal ID transmission control unit 32. Some RFID tags may not require the terminal power supply unit 33.

A description will be given next of a configuration of the control device 20C in the companion animal litter box 1C in accordance with the present embodiment.

As shown in FIG. 10, the control device 20C includes an individual-object-identifying unit 24d in the CPU 24 and an individual-specific body weight measurement memory unit 25a as a second memory unit in the memory unit 25, in addition to the configuration of the control device 20A in accordance with Embodiment 1.

The individual-object-identifying unit 24d in the CPU 24 determines whether or not the signal received as an individual-object-identifying indicator from the terminal communications unit 31 in the information terminal 30 in the collar of the companion animal has a strength greater than or equal to a first threshold value and identifies the individual-object-identifying indicator in the signal having a strength greater than or equal to the first threshold value. This configuration enables the individual-object-identifying unit 24d to determine which companion animal is in the companion animal litter box 1C.

The individual-object-identifying unit 24d in the CPU 24 may alternatively determine which companion animal is in the companion animal litter box 1C if the signal received from the terminal communications unit 31 in the information terminal 30 in the collar of the companion animal has a strength greater than or equal to the first threshold value and subsequently does not change in strength beyond a second threshold value for a period of time. This configuration can prevent the individual-object-identifying unit 24d from producing an erroneous determination, for example, when the companion animal has moved onto the companion animal litter box 1C for body weight measurement, the companion animal only passed by the companion animal litter box 1C, or the companion animal moved onto, but immediately moved down from, the companion animal litter box 1C.

In the companion animal litter box 1C in accordance with the present embodiment, since there is involved a plurality of measurement-target companion animals, the memory unit 25 includes the individual-specific body weight measurement memory unit 25a as the second memory unit, and the individual-specific body weight measurement memory unit 25a stores a body weight measurement as the second weight value of each companion animal, as shown in FIG. 10. In other words, the individual-specific body weight measurement memory unit 25a stores the body weight measurements of the companion animals by associating them with the individual-object-identifying indicators of the companion animals.

The individual companion animals may be identified by a different method.

A description will be given of the companion animal litter box 1C in accordance with the present embodiment with reference to FIG. 11, assuming that there is involved a plurality of companion animals and that an individual animal ID is obtained from the information terminal 30 disposed in advance in the collar of each companion animal to measure the body weight of the companion animal. FIG. 11 is a flow chart representing a process, implemented by the companion animal litter box 1C in accordance with the present embodiment, of measuring the body weights of individual companion animals by obtaining individual animal IDs from the information terminals 30 in the collars of the companion animals.

Referring to FIG. 11, as one of the companion animals moves onto the scale tray 12 of the companion animal litter box 1C (S31), the control device 20C determines from changes in the outputs of the load cells in the body weight measuring instruments 2 that the companion animal has moved onto the scale tray 12 of the companion animal litter box 1C (S32).

The control device 20C then identifies the animal by an individual animal identifying method (S33 and S34). Specifically, the individual-object-identifying unit 24d in the CPU 24 in the control device 20C determines whether or not the signal received from the terminal communications unit 31 in the information terminal 30 in the collar of the companion animal has a strength greater than or equal to the first threshold value and determines the wavelength of the signal having a strength greater than or equal to the first threshold value. The individual-object-identifying unit 24d then determines from the RFID tag of which companion animal the wavelength is coming. This configuration enables the individual-object-identifying unit 24d to determine which companion animal is in the companion animal litter box 1C.

The individual-object-identifying unit 24d in the CPU 24 may alternatively determine which companion animal is in the companion animal litter box 1C if the signal received from the terminal communications unit 31 in the information terminal 30 in the collar of the companion animal has a strength greater than or equal to the first threshold value and subsequently does not change in strength beyond the second threshold value for a period of time.

The control device 20C then retrieves a previous body weight measurement for the identified companion animal from the individual-specific body weight measurement memory unit 25a in the memory unit 25 (S35).

Next, the control device 20C sets the measurement range of the amplifier 22 and the measurement range of the A/D converter 23 to a specific measurement range on the basis of the previous measurement retrieved from the individual-specific body weight measurement memory unit 25a in the memory unit 25 (S36). Weight is measured under these conditions (S37). Then, in the present embodiment, the control device 20C checks whether or not normal measurement can be performed in the specified measurement range for the following reasons. Normal measurement may not be performed in the specified measurement range, for example, when the changes in the body weight of the companion animal differ greatly from the previous measurement. The individual-object-identifying unit 24d in the CPU 24 may wrongly identify companion animals.

If it is determined in step S38 that normal measurement cannot be performed in the specified measurement range, the measurement range is shifted by a prescribed value in a direction in which the measurement range would otherwise extend beyond a limit (S39). The process then returns to step S38 where it is determined whether or not normal measurement can be performed in the specified measurement range.

If it is determined in step S38 that normal measurement can be performed in the specified measurement range, the measurement obtained in this stage is taken as the final measurement (S40).

This final measurement is them stored in the individual-specific body weight measurement memory unit 25a in the memory unit 25 (S41).

As described here, for the body weight measuring instruments 2 as a weight scale for the companion animal litter box 1C in accordance with the present embodiment, there is a plurality of measurement targets each having a communicable individual-object-identifying indicator. The control device 20C includes: the individual-specific body weight measurement memory unit 25a as the second memory unit for storing the weight values of the measurement targets; and the communications unit 27 for receiving the individual-object-identifying indicators of the measurement targets. The CPU 24 identifies, from the individual-object-identifying indicators received by the communications unit 27, which one of the measurement targets is to be measured, then sets up the amplifier 22 for the second measurement range and the second amplification factor on the basis of a weight value obtained in the previous weight measurement on the identified measurement target and stored in the individual-specific body weight measurement memory unit 25a, and thereafter causes the amplifier 22 to amplify the output voltage of the load sensor such as a load cell and the A/D converter 23 to convert the output of the amplifier 22 from analog to digital, to obtain the second weight value of the measurement target.

This configuration enables identifying a measurement target from a plurality of measurement targets and measuring on the basis of an approximate measurement stored in the individual-specific body weight measurement memory unit 25a. The present embodiment can hence omit the first measurement, thereby saving time.

Additionally, for the body weight measuring instruments 2 in accordance with the present embodiment, the CPU 24 sets up the amplifier 22 for the second measurement range and the second amplification factor before measuring the weight of a measurement target using a load sensor such as a load cell. If the output voltage of the load cell extends beyond the second measurement range, the CPU 24 resets the amplifier 22 for a third measurement range that deviates from the second measurement range in a direction in which the output voltage of the load cell extends beyond the second measurement range and causes the amplifier 22 to amplify the output voltage of the load sensor and the A/D converter 23 to convert the output of the amplifier 22 from analog to digital, to obtain the second weight value of the measurement target.

Hence, even when the output voltage of the load sensor falls outside the second measurement range, the second weight value can be obtained in a normal manner, by resetting for the third measurement range.

In the present embodiment, if it is determined in step S38 that normal measurement cannot be performed in the specified measurement range, the measurement range is shifted in step S39 by a prescribed value in a direction in which the measurement range would otherwise extend beyond a limit. The present embodiment is not necessarily limited to this example. It is also possible, as an example, to employ a method of measurement described in Embodiment 1 for the case where the weight of the measurement-target companion animal is not known.

### Software Implementation

The control blocks of the control devices 20A and 20C (particularly, the CPU 24 in the control unit 21) may be implemented by logic circuits (hardware) fabricated, for example, in the form of an integrated circuit (IC chip) and may be implemented by software run by a CPU (central processing unit).

In the latter form of implementation, the CPU 24 includes, among others: a CPU that executes instructions from programs or software by which various functions are implemented; a ROM (read-only memory) or like storage device (referred to as a “storage medium”) containing the programs and various data in a computer-readable (or CPU-readable) format; and a RAM (random access memory) into which the programs are loaded. The computer (or CPU) then retrieves and runs the programs contained in the storage medium, thereby achieving the object of the present invention. The storage medium may be a “non-transitory, tangible medium” such as a tape, a disc/disk, a card, a semiconductor memory, or programmable logic circuitry. The programs may be supplied to the computer via any transmission medium (e.g., over a communications network or by broadcasting waves) that can transmit the programs. The present invention encompasses data signals on a carrier wave that are generated during electronic transmission of the programs.

### General Description

The present invention, in aspect 1 thereof, is directed to a weight scale (body weight measuring instrument 2) including: a load sensor (load cell); an amplifier (amplifier 22); an A/D converter (A/D converter 23); and a control unit (CPU 24) configured to: in a preceding weight measurement on a measurement target, set up the amplifier (amplifier 22) for a first measurement range and a first amplification factor and cause the amplifier (amplifier 22) to amplify an output voltage of the load sensor (load cell) and the A/D converter (A/D converter 23) to convert an output of the amplifier (amplifier 22) from analog to digital, to obtain a first weight value of the measurement target; and in a succeeding weight measurement on the measurement target, set up the amplifier (amplifier 22) for a second measurement range narrower than the first measurement range and a second amplification factor larger than the first amplification factor and then cause the amplifier (amplifier 22) to amplify the output voltage of the load sensor (load cell) and the A/D converter (A/D converter 23) to convert an output of the amplifier (amplifier 22) from analog to digital, to obtain a second weight value of the measurement target.

In this configuration, the weight scale includes a load sensor, an amplifier, and an A/D converter. This type of weight scale generally performs a first weight measurement (i.e., preceding weight measurement) to measure the weight of a measurement target. Specifically, the amplifier is set up for a first measurement range and a first amplification factor to amplify an output voltage of the load sensor, and the A/D converter converts an output of the amplifier from analog to digital, to obtain a first weight value of the measurement target. The weight scale however often includes a general-purpose amplifier and A/D converter that do not provide high-precision, high-resolution performance. The first measurement, that is, the preceding measurement, is not capable of performing a high-precision weight measurement in such cases. For instance, if a load cell such as a load sensor with a rating of 20 kg is used, for example, to measure the weight of 15 kg, the result will be sufficiently precise. On the other hand, if the load cell is used to measure the weight of 15.1 kg, the result will contain unreliable digits after the decimal point.

Accordingly, the weight scale, after performing the preceding weight measurement on the measurement target by the method described above, continues the process by performing a second weight measurement (i.e., succeeding weight measurement) on the measurement target in an aspect of the present invention. In the succeeding weight measurement on the measurement target, the amplifier is set up for a second measurement range narrower than the first measurement range and a second amplification factor larger than the first amplification factor. Then the amplifier amplifies the output voltage of the load sensor, and the A/D converter converts an output of the amplifier from analog to digital, to obtain a second weight value of the measurement target.

In this configuration, even if a general-purpose amplifier and A/D converter that do not provide high-precision, high-resolution performance are used, an approximate measurement is obtained in the preceding weight measurement. The measurement range of the amplifier is then narrowed down to the second measurement range, so that the amplifier is set up for the second, larger amplification factor. As a result, the second weight value of the measurement target obtained in the succeeding weight measurement is more precise than the first weight value of the measurement target obtained in the preceding weight measurement.

The present invention, in an aspect thereof, simply uses twice the general-purpose amplifier and A/D converter that do not provide high-precision, high-resolution performance, in order to obtain this second, high-precision weight value. A substantially high-precision, high-resolution measurement is thus generated by using a simple configuration.

The resultant weight scale hence readily enables high-precision weight measurement by using an amplifier and an A/D converter that do not provide high-precision, high-resolution performance.

In aspect 2 of the present invention, the weight scale (body weight measuring instrument 2) further includes a first memory unit (memory unit 25) that stores a weight value of the measurement target, wherein the control unit (CPU 24), in weight measurement on the measurement target, sets up the amplifier (amplifier 22) for the second measurement range and the second amplification factor based on a weight value obtained in the preceding weight measurement and stored in the first memory unit (memory unit 25), then causes the amplifier (amplifier 22) to amplify the output voltage of the load sensor (load cell), and causes the A/D converter (A/D converter 23) to convert an output of the amplifier (amplifier 22) from analog to digital, to obtain the second weight value of the measurement target.

For instance, if the weight of the measurement target is measured regularly every day, and if the measurement is stored in a memory unit, an approximate measurement of the measurement target is available by retrieving a previous measurement from the memory unit, without having to perform the first weight measurement. Therefore, a measurement can be performed with the amplifier being set up for the second measurement range and the second amplification factor from the start of the measurement process, without having to perform the first measurement using the first measurement range and the first amplification factor.

Accordingly, in an aspect of the present invention, the weight value of the measurement target is stored in the first memory unit, and in weight measurement on the measurement target, the amplifier is set up for the second measurement range and the second amplification factor based on a weight value obtained in the preceding weight measurement and stored in the memory unit and then amplifies the output voltage of the load sensor. The A/D converter converts an output of the amplifier from analog to digital, to obtain the second weight value of the measurement target.

This configuration can perform the second measurement on the measurement target for obtaining a high definition measurement by omitting the first weight measurement on the measurement target and setting up, from the start of the measurement process, the amplifier for the second measurement range and the second amplification factor on the basis of the second, preceding weight value stored in the first memory unit. The configuration hence saves time.

In aspect 3 of the present invention, in the weight scale (body weight measuring instrument 2), the measurement target includes a plurality of measurement targets each having a communicable individual-object-identifying indicator. The weight scale (body weight measuring instrument 2) further includes: a second memory unit (individual-specific body weight measurement memory unit 25a) that stores weight values of the measurement targets; and a communications unit 27 that receives the individual-object-identifying indicators of the measurement targets, wherein the control unit (CPU 24) identifies, from the individual-object-identifying indicators received by the communications unit 27, which one of the measurement targets is to be measured, then sets up the amplifier (amplifier 22) for the second measurement range and the second amplification factor based on a weight value obtained in the preceding weight measurement on the identified measurement target and stored in the second memory unit (individual-specific body weight measurement memory unit 25a), and thereafter causes the amplifier (amplifier 22) to amplify the output voltage of the load sensor (load cell) and the A/D converter (A/D converter 23) to convert an output of the amplifier (amplifier 22) from analog to digital, to obtain the second weight value of the measurement target.

For instance, when there is involved a plurality of measurement targets, the first measurement can be omitted if a measurement target can be identified.

Accordingly, in an aspect of the present invention, there is involved a plurality of measurement targets, and each measurement target includes a communicable individual-object-identifying indicator. The weight scale includes: a second memory unit that stores weight values of the measurement targets; and a communications unit that receives the individual-object-identifying indicators of the measurement targets, wherein the control unit identifies, from the individual-object-identifying indicators received by the communications unit, which one of the measurement targets is to be measured, then sets up the amplifier for the second measurement range and the second amplification factor based on a weight value obtained in the preceding weight measurement on the identified measurement target and stored in the second memory unit, and thereafter causes the amplifier to amplify the output voltage of the load sensor and the A/D converter to convert an output of the amplifier from analog to digital, to obtain the second weight value of the measurement target.

This configuration enables identifying a measurement target from a plurality of measurement targets and measuring on the basis of an approximate measurement stored in the second memory unit. The configuration can hence omit the first measurement, thereby saving time.

In aspect 4 of the present invention, the weight scale (body weight measuring instrument 2) is preferably such that the control unit (CPU 24), to cause the amplifier (amplifier 22) to amplify the output voltage of the load sensor (load cell), corrects the output voltage of the load sensor (load cell) and causes the amplifier to amplify by the first amplification factor or the second amplification factor, such that an output of the amplifier (amplifier 22) falls in an input range of the A/D converter (A/D converter 23) when the amplifier is set up for the first measurement range or the second measurement range.

For instance, the output voltage of the load sensor such as a load cell may go negative for a light load. In such cases, the output of the amplifier may not fall in the input range of the A/D converter when the amplifier is set up for the first measurement range or the second measurement range. The first amplification factor or the second amplification factor is therefore not applicable to all measurement ranges.

Accordingly, in an aspect of the present invention, the control unit, to cause the amplifier to amplify the output voltage of the load sensor, corrects the output voltage of the load sensor and causes the amplifier to amplify by the first amplification factor or the second amplification factor, such that an output of the amplifier falls in an input range of the A/D converter when the amplifier is set up for the first measurement range or the second measurement range.

This configuration enables the amplifier to, when the amplifier is set up for the first measurement range or the second measurement range, generate an output that falls in the input range of the A/D converter across the entire first measurement range or second measurement range. Therefore, normal first and second weight values are obtained.

In aspect 5 of the present invention, the weight scale (body weight measuring instrument 2) is preferably such that the control unit (CPU 24) sets up the amplifier (amplifier 22) for the second measurement range and the second amplification factor, then if the output voltage of the load sensor (load cell) extends beyond the second measurement range in weight measurement on the measurement target using the load sensor (load cell), sets up the amplifier (amplifier 22) for a third measurement range obtained by shifting the second measurement range toward a side where the output voltage of the load sensor (load cell) falls outside the second measurement range, and causes the amplifier (amplifier 22) to amplify the output voltage of the load sensor (load cell) and the A/D converter (A/D converter 23) to convert an output of the amplifier (amplifier 22) from analog to digital, to obtain the second weight value of the measurement target.

For instance, if the weight of a measurement target is measured for the first time in an extended period of time, and if the amplifier is set up for the second measurement range and the second amplification factor on the basis of the second weight value obtained in a previous measurement, the measurement may not fall in the second measurement range.

In such cases, in an aspect of the present invention, after the control unit sets up the amplifier for the second measurement range and the second amplification factor, if the output voltage of the load sensor in weight measurement on the measurement target falls outside the second measurement range, the amplifier is set up for a third measurement range obtained by shifting the second measurement range toward a side where the output voltage of the load sensor falls outside the second measurement range and amplifies the output voltage of the load sensor, and the A/D converter converts an output of the amplifier from analog to digital, to obtain the second weight value of the measurement target.

In this configuration, normal second weight value is obtained by setting up the amplifier for the third measurement range even if the output voltage of the load sensor extends beyond the second measurement range.

The present invention, in aspect 6 thereof, is directed to a method of measuring weight by using a load sensor (load cell), an amplifier (amplifier 22), and an A/D converter (A/D converter 23), the method including: a first step where in a preceding weight measurement on a measurement target, the amplifier (amplifier 22) is set up for a first measurement range and a first amplification factor to amplify an output voltage of the load sensor (load cell), and the A/D converter (A/D converter 23) converts an output of the amplifier (amplifier 22) from analog to digital, to obtain a first weight value of the measurement target; and a second step where in a succeeding weight measurement on the measurement target, the amplifier (amplifier 22) is set up for a second measurement range narrower than the first measurement range and a second amplification factor larger than the first amplification factor, then the amplifier (amplifier 22) amplifies the output voltage of the load sensor (load cell), and the A/D converter (A/D converter 23) converts an output of the amplifier (amplifier 22) from analog to digital, to obtain a second weight value of the measurement target.

This configuration provides a method of measuring weight that readily enables high-precision weight measurement by using an amplifier and an A/D converter that do not provide high-precision, high-resolution performance.

The present invention, in aspect 7 thereof, is directed to an animal litter box (companion animal litter box 1A, 1B, or 1C) including the weight scale described above as the body weight measuring instrument 2.

This configuration provides an animal litter box including a weight scale that readily enables high-precision weight measurement by using an amplifier and an A/D converter that do not provide high-precision, high-resolution performance.

The present invention is not limited to the description of the embodiments above and may be altered within the scope of the claims. Embodiments based on a proper combination of technical means disclosed in different embodiments are encompassed in the technical scope of the present invention.

### REFERENCE SIGNS LIST

1A, 1B, and 1C Companion Animal Litter Box
2 Body Weight Measuring Instrument (Weight Scale)
3 Urine Weight Measuring Instrument
4 Smartphone
11 Main Body Container
12 Scale Tray
13 Litter Tray
14 Absorbent Sheet
20A and 20C, 20C Control Device
21 Control Unit
22 Amplifier
23 A/D Converter
24 CPU (Control Unit)
24a Weight Measurement Control Unit
24b Animal Presence Determining Unit
24c Urination/defecation Determining Unit
24d Individual-object-identifying Unit
25 Memory Unit (First Memory Unit)
25a Individual-specific Body Weight Measurement Memory Unit (Second Memory Unit)
27 Communications Unit
30 Information Terminal
31 Terminal Communications Unit
32 Individual Animal ID Transmission Control Unit

1. A weight scale comprising:
a load sensor;
an amplifier;
an A/D converter; and
a control unit configured to:
in a preceding weight measurement on a measurement target, set up the amplifier for a first measurement range and a first amplification factor and cause the amplifier to amplify an output voltage of the load sensor and the A/D converter to convert an output of the amplifier from analog to digital, to obtain a first weight value of the measurement target; and
in a succeeding weight measurement on the measurement target, set up the amplifier for a second measurement range narrower than the first measurement range and a second amplification factor larger than the first amplification factor and then cause the amplifier to amplify the output voltage of the load sensor and the A/D converter to convert an output of the amplifier from analog to digital, to obtain a second weight value of the measurement target.

2. The weight scale according to claim 1, further comprising a first memory unit that stores a weight value of the measurement target, wherein
the control unit, in weight measurement on the measurement target, sets up the amplifier for the second measurement range and the second amplification factor based on a weight value obtained in the preceding weight measurement and stored in the first memory unit, then causes the amplifier to amplify the output voltage of the load sensor, and causes the A/D converter to convert an output of the amplifier from analog to digital, to obtain the second weight value of the measurement target.

3. The weight scale according to claim 1, the measurement target comprising a plurality of measurement targets each having a communicable individual-object-identifying indicator,
the weight scale further comprising:
a second memory unit that stores weight values of the measurement targets; and
a communications unit that receives the individual-object-identifying indicators of the measurement targets, wherein
the control unit identifies, from the individual-object-identifying indicators received by the communications unit, which one of the measurement targets is to be measured, then sets up the amplifier for the second measurement range and the second amplification factor based on a weight value obtained in the preceding weight measurement on the identified measurement target and stored in the second memory unit, and thereafter causes the amplifier to amplify the output voltage of the load sensor and the A/D converter to convert an output of the amplifier from analog to digital, to obtain the second weight value of the measurement target.

4. The weight scale according to claim 1, wherein the control unit, to cause the amplifier to amplify the output voltage of the load sensor, corrects the output voltage of the load sensor and causes the amplifier to amplify by the first amplification factor or the second amplification factor, such that an output of the amplifier falls in an input range of the A/D converter when the amplifier is set up for the first measurement range or the second measurement range.

5. The weight scale according to claim 1, wherein the control unit sets up the amplifier for the second measurement range and the second amplification factor, then if the output voltage of the load sensor falls outside the second measurement range in weight measurement on the measurement target using the load sensor, sets up the amplifier for a third measurement range obtained by shifting the second measurement range toward a side where the output voltage of the load sensor falls outside the second measurement range, and causes the amplifier to amplify the output voltage of the load sensor and the A/D converter to convert an output of the amplifier from analog to digital, to obtain the second weight value of the measurement target.

6. A method of measuring weight by using a load sensor, an amplifier, and an A/D converter, the method comprising:
a first step where in a preceding weight measurement on a measurement target, the amplifier is set up for a first measurement range and a first amplification factor to amplify an output voltage of the load sensor, and the A/D converter converts an output of the amplifier from analog to digital, to obtain a first weight value of the measurement target; and
a second step where in a succeeding weight measurement on the measurement target, the amplifier is set up for a second measurement range narrower than the first measurement range and a second amplification factor larger than the first amplification factor, then the amplifier amplifies the output voltage of the load sensor, and the A/D converter converts an output of the amplifier from analog to digital, to obtain a second weight value of the measurement target.

7. An animal litter box comprising the weight scale according to claim 1 as a body weight measuring instrument.
